(19) United States
(12) Patent Application Publication
(10) Pub. No.: US 2022/0224416 A1
(43) Pub. Date: Jul. 14, 2022

(54) OPTICAL TRANSMITTER AND METHOD OF MANUFACTURING OPTICAL TRANSMITTER

(71) Applicant: Fujitsu Optical Components Limited, Kawasaki-shi (JP)

(72) Inventor: KAZUYA BUMA, KAWASAKI (JP)

(73) Assignee: Fujitsu Optical Components Limited, Kawasaki-shi (JP)

(21) Appl. No.: 17/538,151

(22) Filed: Nov. 30, 2021

(30) Foreign Application Priority Data
Jan. 8, 2021 (JP) 2021-001828

(51) Int. Cl. H04B 10/516

(52) U.S. Cl. CPC H04B 10/516

(57) ABSTRACT

An optical transmitter includes an optical modulator configured to modulate an input light and output an optical signal, a bias controller configured to control a bias applied to the optical modulator, an attenuator configured to attenuate the optical signal output from the optical modulator and output the attenuated optical signal, a positive monitor configured to detect a forward optical signal included in the attenuated optical signal output from the attenuator, a negative monitor configured to detect a complementary optical signal included in the attenuated optical signal output from the attenuator, and a controller configured to control the bias controller based on a sum of a first dither of a positive signal output from the positive monitor and a second dither of a negative signal output from the negative monitor.

### CROSS-REFERENCE TO RELATED APPLICATIONS

The present application is based upon and claims the benefit of priority from the prior Japanese Patent Application No. 2021-001828 filed on Jan. 8, 2021, with the Japanese Patent Office, the entire contents of which are incorporated herein by reference.

### FIELD

The disclosures herein relate to an optical transmitter and a method of manufacturing an optical transmitter.

### BACKGROUND

Optical transmitters used in optical transceivers and the like include optical modulators, and automatic bias control (ABC) is performed on the optical modulators.

However, there is a case in which existing optical transmitters cannot easily stabilize the ABC of the optical modulator.

### RELATED-ART DOCUMENTS

### Patent Document

[Patent Document 1] Japanese Laid-Open Patent Publication No. 2009-288509
[Patent Document 2] Japanese Laid-Open Patent Publication No. 2012-128165
[Patent Document 3] U.S. Pat. No. 8,041,228

### SUMMARY

According to an aspect of the embodiment, an optical transmitter includes an optical modulator configured to modulate an input light and output an optical signal, a bias controller configured to control a bias applied to the optical modulator, an attenuator configured to attenuate the optical signal output from the optical modulator and output the attenuated optical signal, a positive monitor configured to detect a forward optical signal included in the attenuated optical signal output from the attenuator, a negative monitor configured to detect a complementary optical signal included in the attenuated optical signal output from the attenuator, and a controller configured to control the bias controller based on a sum of a first dither of a positive signal output from the positive monitor and a second dither of a negative signal output from the negative monitor.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an optical transmitter according to a reference example;

FIG. 2 is a block diagram illustrating an optical transmitter according to an embodiment; and

FIG. 3 is a time chart illustrating an operation of the optical transmitter according to the embodiment.

### DESCRIPTION OF EMBODIMENTS

According to an aspect of the embodiment, an optical transmitter includes an optical modulator configured to modulate an input light and output an optical signal, a bias controller configured to control a bias applied to the optical modulator in order to adjust differential static phase of Machzehnder interferometer to the optimum point, an attenuator configured to attenuate the optical signal output from the optical modulator and output the attenuated optical signal, a positive monitor configured to detect a branched optical power proportional to the output power of an output optical signal from the attenuator, a negative monitor configured to detect an optical power complimentary to (i.e., negatively proportional to) the output power of the output optical signal from the attenuator, and a controller configured to control the bias based on a sum of a first dither detected by the positive monitor and a second dither detected by the negative monitor.

In the following, an embodiment of the present disclosure will be specifically described in detail with reference to the accompanying drawings. In the present specification and the drawings, components having substantially the same functional configuration are referenced by the same reference numerals and overlapped description may be omitted.

### Reference Example

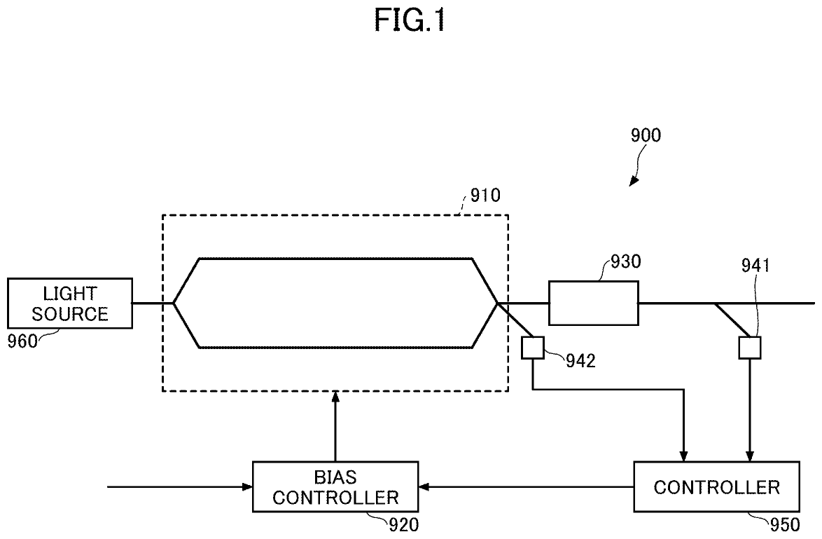

First, a reference example will be described. FIG. 1 is a block diagram illustrating an optical transmitter according to the reference example.

As illustrated in FIG. 1, an optical transmitter 900 according to the reference example includes an optical modulator 910, a bias controller 920, an attenuator 930, a positive monitor 941, a negative monitor 942, and a controller 950.

The optical modulator 910 modulates a continuous wave (CW) light output from a light source 960 as an input light and outputs the modulated light as an optical signal. The bias controller 920 adds a bias to an input data signal (an electric signal) based on control of the controller 950 and generates a drive signal to drive the optical modulator 910. The attenuator 930 attenuates the optical signal output from the optical modulator 910 and outputs the attenuated optical signal. The positive monitor 941 monitors a forward optical signal output from the attenuator 930 to output an electric signal proportional to the forward optical signal, which is a monitor value. The negative monitor 942 monitors a complementary optical signal output from the optical modulator 10 to output an electric signal negatively proportional to the attenuator output, which is a monitor value. The positive monitor 941 and the negative monitor 942 are, for example, photodiodes (PD).

The optical transmitter 900 has two operation modes: Tx_Disable and Tx_Enable. In the operation mode Tx_Disable, the light source 960 is turned off, the attenuator 930 is in a closed state, and the controller 950 controls the bias controller 920 based on an output signal from the negative monitor 942. In the operation mode Tx_Enable, the light source 960 is turned on, the attenuator 930 is in an open state, and the controller 950 controls the bias controller 920 based on an output signal from the positive monitor 941.

As described, in the optical transmitter 900, the bias of the optical modulator 910 is controlled based on different output signals between two operation modes of Tx_Disable and Tx_Enable. Thus, it may be difficult to stabilize the modulator bias by ABC. Additionally, in the optical transmitter 900, a shift of the bias point from the optimum point, what is called “bias shift”, may be caused if the negative monitor 942 is used for adjusting the bias point. In such a case, when the operation mode transitions from Tx_Disable to Tx_Enable, the bias is not easily stabilized at the beginning of Tx_Enable, and the wait time until the bias is stabilized may be longer.

The inventor of the present application, in view of such characteristics of the optical transmitter 900, has made an intense investigation to stabilize the bias of the optical modulator, and as a result, has arrived at the following embodiment.

### Embodiment

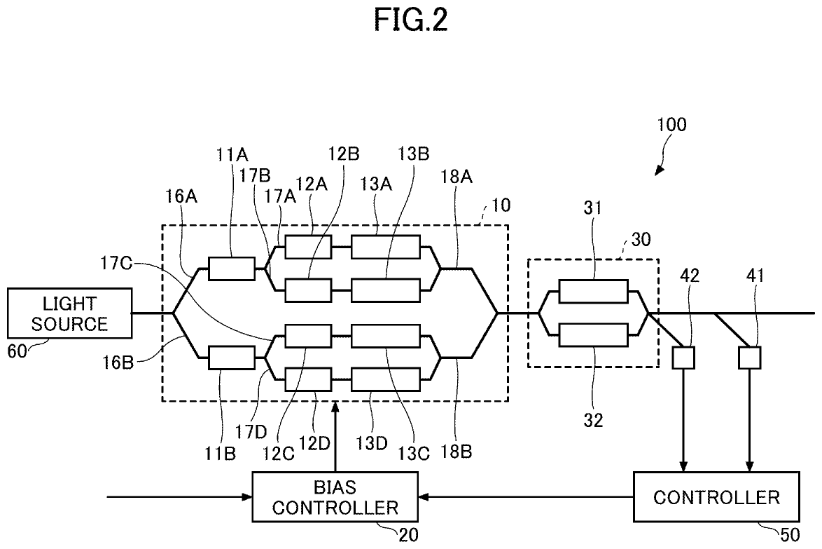

Next, an optical transmitter according to the embodiment will be described. FIG. 2 is a block diagram illustrating the optical transmitter according to the embodiment.

As illustrated in FIG. 2, an optical transmitter 100 according to the embodiment includes an optical modulator 10, a bias controller 20, an attenuator 30, a positive monitor 41, a negative monitor 42, and a controller 50.

The optical modulator 10 modulates the CW light output from the light source 60 as an input light and outputs the modulated light as an optical signal. The optical modulator 10 includes, for example, a Mach-Zehnder (MZ) modulator. The optical modulator 10 operates using an applied bias. The optical modulator 10 includes a phase shifter 11A provided in an optical waveguide 16A and a phase shifter 11B provided in an optical waveguide 16B. The optical waveguide 16A is one waveguide of two waveguides branched from an input section and the optical waveguide 16B is the other waveguide of the two waveguides. The optical modulator 10 further includes a phase shifter 12A and a phase modulator 13A provided on an optical waveguide 17A and a phase shifter 12B and a phase modulator 13B provided on an optical waveguide 17B. The optical waveguide 17A is one waveguide of two waveguides branched from the optical waveguide 16A and the optical waveguide 17B is the other waveguide of the two waveguides. The optical modulator 10 further includes a phase shifter 12C and a phase modulator 13C provided on an optical waveguide 17C and a phase shifter 12D and a phase modulator 13D provided on an optical waveguide 17D. The optical waveguide 17C is one waveguide of two waveguides branched from the optical waveguide 16B and the optical waveguide 17D is the other waveguide of the two waveguides. The optical waveguide 17A and the optical waveguide 17B are coupled to the optical waveguide 18A, the optical waveguide 17C and the optical waveguide 17D are coupled to the optical waveguide 18B, and the optical waveguide 18A and the optical waveguide 18B are coupled to one optical waveguide (an output section).

The bias controller 20 adds a bias to an input data signal (an electric signal) output from a digital signal processor (DSP) or the like based on control of the controller 50 and generates a drive signal to drive the optical modulator 10. That is, the bias controller 20 controls the bias applied to the optical modulator 10.

The attenuator 30 attenuates an optical signal output from the optical modulator 10 and outputs the attenuated optical signal. The attenuator 30 includes a first phase shifter 31 and a second phase shifter 32. The first phase shifter 31 shifts a phase of the branched part of the optical signal output from the optical modulator 10 and outputs the phase-shifted optical signal. The second phase shifter 32 shifts a phase of the other branched part of the optical signal output from the optical modulator 10 to a direction opposite to the phase shift in the first phase shifter and outputs the inversely-phase-shifted optical signal. The optical signal output from the attenuator 30 includes coupled outputs from the first phase shifter and the second phase shifter. The coupled outputs include dithers.

The positive monitor 41 monitors the forward optical signal output from the attenuator 30 and outputs an electric signal proportional to the output power of the output of the attenuator 30 (i.e., an electric positive signal), which is a monitor value. The negative monitor 42 monitors the complementary optical signal output from the attenuator 30 and outputs an electric signal complementary to the output power of the output of the attenuator 30 (i.e., an electric negative signal), which is a monitor value. The positive monitor 41 and the negative monitor 42 are, for example, PDs. The electric positive signal and the electric negative signal also include dithers.

The controller 50 controls the bias controller 20 based on the sum of a first dither of the positive signal output from the positive monitor 41 and a second dither of the negative signal output from the negative monitor 42. For example, the sum of the first dither and the second dither is within a predetermined range, and the sum of the first dither and the second dither is preferably substantially constant. The controller 50 controls the bias controller 20 to generate, for example, a bias on which the dither is superimposed.

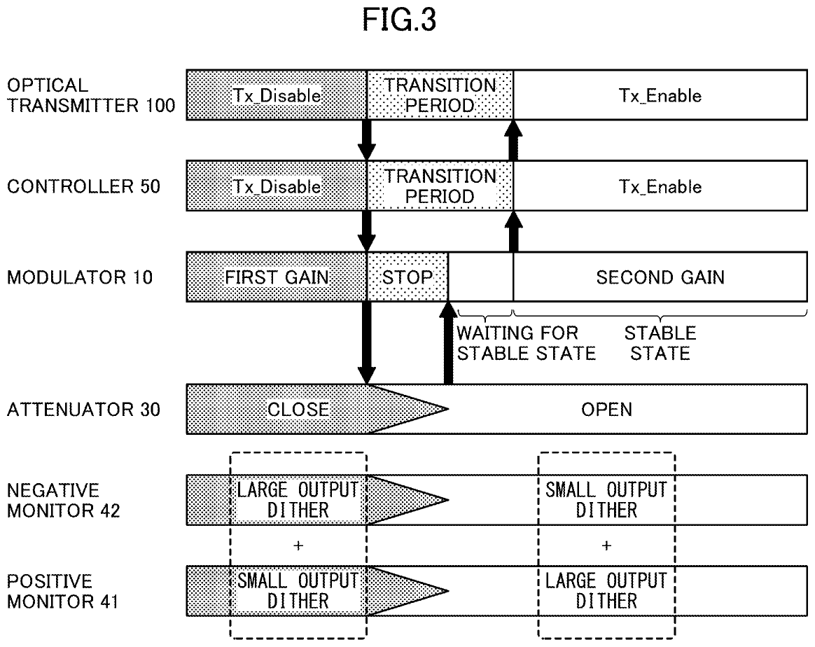

Here, the operation of the optical transmitter 100 will be described. The operation is an example of a control method of the optical transmitter 100 that is performed mainly by the controller 50. FIG. 3 is a time chart illustrating the operation of the optical transmitter 100 according to the embodiment. The optical transmitter 100 has two operation modes of: Tx_Disable and Tx_Enable. Tx_Disable is an operation mode in which optical transmission is stopped. In contrast, Tx_Enable is an operation mode in which optical transmission is performed. The controller 50 controls the bias controller 20 so as to generate a bias on which the dither is superimposed in both Tx_Disable and Tx_Enable. Tx_Disable is an example of a first operation mode, and Tx_Enable is an example of a second operation mode.

When the optical transmitter 100 is in the operation mode Tx_Disable, the controller 50 is in a Tx_Disable state, and the optical modulator 10 is controlled with a first gain for feedback control loop of the bias according to the dither. Additionally, the attenuator 30 is in a closed state. Thus, the second dither of the negative signal output from the negative monitor 42 is larger than the first dither of the positive signal output from the positive monitor 41.

When the optical transmitter 100 is in the operation mode Tx_Enable, the controller 50 is in a Tx_Enable state, and the optical modulator 10 is controlled with a second gain. Additionally, the attenuator 30 is in an open state. Thus, the first dither of the positive signal output from the positive monitor 41 is larger than the second dither of the negative signal output from the negative monitor 42.

When the operation mode is switched from Tx_Disable to Tx_Enable, a certain transition period occurs. In the transition period, the controller 50 enters a transition state, and the optical modulator 10 stops simultaneously with the cancellation of Tx_Disable. The controller 50 controls the bias controller 20 based on the sum of the first dither and the second dither even during the transition period. Additionally, the attenuator 30 transitions from the closed state to the open state, and accordingly the second dither is gradually reduced and the first dither gradually increases. When the attenuator 30 is in the open state, the operation of the optical modulator 10 starts, and when the bias of the optical modulator 10 is stabilized at the second gain, the operation mode becomes Tx_Enable.

The controller 50 controls the bias controller 20 based on the sum of the first dither and the second dither in the operation mode Tx_Disable, in the operation mode Tx_Enable, and in the transition period between Tx_Disable and Tx_Enable. As described above, the first dither and the second dither change, but the sum of the first dither and the second dither is substantially constant and within a predetermined range. Therefore, according to the present embodiment, the first gain and the second gain can be easily matched, and the bias of the optical modulator 10 can be easily stabilized.

Additionally, because the bias controller 20 is continuously controlled based on the sum of the first dither and the second dither, a shift of the bias does not easily occur, and thus the bias of the optical modulator 10 is stabilized at the second gain within a short period of time after the operation of the optical modulator 10 has started. Therefore, the wait time until the gain is stabilized can be reduced.

The optical transmitter 100 can be used, for example, in an optical transceiver.

According to at least one embodiment of the present disclosure, the bias of the optical modulator can be easily stabilized.

Although the preferred embodiment and the like have been described in detail above, the present invention is not limited to the above-described embodiment and the like. Various modifications and substitutions can be made to the above-described embodiment without departing from the scope of the claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An optical transmitter comprising:
an optical modulator configured to modulate an input light and output an optical signal;
a bias controller configured to control a bias applied to the optical modulator;
an attenuator configured to attenuate the optical signal output from the optical modulator and output the attenuated optical signal;
a positive monitor configured to detect a forward optical signal included in the attenuated optical signal output from the attenuator;
a negative monitor configured to detect a complementary optical signal included in the attenuated optical signal output from the attenuator; and
a controller configured to control the bias controller based on a sum of a first dither of a positive signal output from the positive monitor and a second dither of a negative signal output from the negative monitor.

2. The optical transmitter as claimed in claim 1, wherein the attenuator includes
a first phase shifter configured to output a positively-phase-shifted optical signal as the forward optical signal, and
a second phase shifter configured to output a negatively-phase-shifted optical signal as the complementary optical signal.

3. The optical transmitter as claimed in claim 1, wherein the controller controls the bias controller based on the sum of the first dither and the second dither in a period of a first operation mode, a period of a second operation mode, and a transition period from the first operation mode to the second operation mode, the first operation mode being an operation mode in which optical transmission is stopped, and the second operation mode being an operation mode in which the optical transmission is performed.

4. The optical transmitter as claimed in claim 1, wherein the sum of the first dither and the second dither is within a predetermined range.

5. The optical transmitter as claimed in claim 1, wherein the controller controls the bias controller so as to generate a bias on which a dither is superimposed.

6. A control method of an optical transmitter including
an optical modulator configured to modulate an input light to output an optical signal;
a bias controller configured to control a bias applied to the optical modulator; and
an attenuator configured to attenuate the optical signal output from the optical modulator to output the attenuated optical signal, the optical transmitter including a positive monitor configured to detect a forward optical signal included in the attenuated optical signal output from the attenuator and a negative monitor configured to detect a complementary optical signal included in the attenuated optical signal output from the attenuator, the control method comprising controlling the bias controller based on a sum of a first dither of a positive signal output from the positive monitor and a second dither of a negative signal output from the negative monitor.
